(19) United States
(12) Patent Application Publication
(10) Pub. No.: US 2012/0102405 A1
(43) Pub. Date: Apr. 26, 2012

(54) SYSTEM AND METHOD FOR MATCHING PERSON-SPECIFIC DATA WITH EVIDENCE RESULTING IN RECOMMENDED ACTIONS

(75) Inventors: Diane B. Zuckerman, New York, NY (US); Peter Muldoon, North Arlington, NJ (US)

(73) Assignee: EVIDENCE-BASED SOLUTIONS, INC., New York, NY (US)

(21) Appl. No.: 13/280,947

(22) Filed: Oct. 25, 2011

Related U.S. Application Data
(60) Provisional application No. 61/406,520, filed on Oct. 25, 2010.

(51) Int. Cl. G06F 3/01; G06F 15/16

(52) U.S. Cl. 715/733

(57) ABSTRACT

There is provided a method that includes (a) receiving first information about a patient via a first user interface that is communicatively coupled to a communication network, (b) receiving second information about the patient via a second user interface that is communicatively coupled to the communication network, where the first information and the second information, together, comprise answered questions, (c) evaluating the answered questions, to yield a suggested diagnosis and a follow-up question, and (d) transmitting the suggested diagnosis and the follow-up question to the second user interface via the communication network. There is also provided a system that employs the method, and a storage device that contains instructions that cause a processor to perform the method.

The present application is claiming priority of U.S. Provisional Patent Application Ser. No. 61/406,520, filed on Oct. 25, 2010, the content of which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present disclosure relates to improving person-specific diagnostic analysis and personalized management of individuals. Particularly, the present disclosure relates to a system and method for matching and mapping person-specific data with validated evidence to provide predictive intelligence and continuous cognitive support in decision making.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The current political emphasis on the deficiencies and problems within the healthcare industry serve to highlight a systemic breakdown of communication on an individual and systematic level.

In the healthcare industry, the recent push toward digital records highlights the pressure that technology places on the existing practice of medicine and underscores a similar communication and knowledge-transfer breakdown between patients, doctors, hospitals, clinics, and all ancillary healthcare services within the medical industry at large. In particular, healthcare providers, systems and patients lack the tools necessary to effectively collect patient data and correlate such data with the wider evidence-based industry knowledge and expertise to render accurate and efficient diagnosis. Further, no system yet exists that learns and incorporates positive outcomes derived from the users to provide predictive intelligence, improving the model with real-world use.

Computer-assisted questionnaire systems have been developed in the healthcare industry and focus on providing potential patient diagnoses, monitoring treatment plans, and tracking the progression of a diagnosed condition. These systems originate at the medical professional level and are used primarily by doctors in treating patients. As such, patients rely upon the medical professional's answer to questions to arrive at a diagnosis. The medical professionals, due to human error factors, or even inherent bias, may ignore or skip certain patient symptoms and arrive at an erroneous diagnosis. Conversely, in systems where patients have access to such questionnaires, requisite levels of medical knowledge to adequately complete questions are lacking.

One technique to improve such communication is a computer assisted clinical questionnaires disclosed in U.S. Patent Application Publication No. 2002/0035486. The system in the U.S. 2002/0035486 publication provides an individualized question-set based upon previous answers. Questions are organized in sets and levels of conditional dependence are established, whereby a positive or negative response to a prior question will factor in producing the follow-up question. Through this process a diagnosis is ultimately rendered. The system in the U.S. 2002/0035486 publication inherently focuses on an outcome-dispositive result and is limited by the clinician designing the particular questionnaire because each clinician is responsible for creating appropriate dependence for subsequent questions. The system in the U.S. 2002/0035486 publication focuses on a result and overlooks important factors such as client histories and other client specific data.

DXplain is a decision support system for medical professionals (including medical students). A medical professional provides clinical information about a patient, such as physical signs, symptoms, and laboratory data. Based on this information, a ranked list of diagnoses is generated that represents classically associated clinical diagnoses. However, DXplain neglects important historical patient information and is only accessible by medical professionals.

U.S. Patent Application Publication No. 2009/0259494 discloses another technique to correlate clinical patient data with a diagnosis. It describes a computer implemented system that makes a probabilistic determination of diagnosis by discarding subjective qualities of clinical data such as disease prevalence and intensity of symptoms. Instead, a mathematical formulation is used to compare objective clinical data to a diagnostic database to produce a probability of diagnosis. One focus of the system in the U.S. 2009/0259494 publication is associating a cost with unresolved patient data. Put simply, the system in the U.S. 2009/0259494 publication analyzes the cost of acquiring further data to yield a statistically higher probability of diagnosis or a higher probability of eliminating a likely diagnosis ultimately resulting in additional cost to the patient. Such a system, similar to other attempts and techniques, is implemented at the medical professional level and is not available for patient input. Additionally, the system in the U.S. 2009/0259494 publication disregards prevalence of a disease and historical records of a particular patient, including ancestry and prior diagnosis.

Despite efforts to date, a need remains for matching and mapping person-specific data with evidence that results in person-specific or personalized recommended actions. In particular, the present disclosure overcomes the deficiencies of prior attempts as such system provides the tools necessary to effectively collect patient data and correlate such data with a wider evidence-based industry of knowledge and expertise to render accurate and efficient diagnosis through a defined process. Additionally, as this real-world data is collected and mapped resulting in positive outcomes, the system gets smarter and more efficient. These and other needs are advantageously satisfied by the disclosed systems and methods for achieving person-specific cognitive support.

### SUMMARY OF THE INVENTION

It is an object of the present invention to provide a method and a system for matching person-specific data with evidence.

In this regard, there is provided a method that includes (a) receiving first information about a patient via a first user interface that is communicatively coupled to a communication network, (b) receiving second information about the patient via a second user interface that is communicatively coupled to the communication network, where the first information and the second information, together, comprise answered questions, (c) evaluating the answered questions, to yield a suggested diagnosis and a follow-up question, and (d) transmitting the suggested diagnosis and the follow-up question to the second user interface via the communication network. There is also provided a system that employs the method, and a storage device that contains instructions that cause a processor to perform the method.

An advantage of such a system is that it provides objective clinical reasoning or proof of positive concept validation, and suggestion of a next question or a next test based on previous information, and thus further provides cognitive support for moving the diagnostician forward in defining the condition based on specific weighted and ranked concepts attributable to the patient.

Additional objects, advantages and novel features of the invention will be set forth in part in the description, examples and figures which follow, all of which are intended to be for illustrative purposes only, and not intended in any way to limit the invention, and in part will become apparent to those skilled in the art on examination of the following, or may be learned by practice of the invention.

### BRIEF DESCRIPTION OF THE DRAWINGS

FIG. 1 is a block diagram of a system for employment of the present invention.

FIG. 2 is a functional block diagram of a program module.

FIG. 3 is diagram that shows condition ranking for a question and two conditions.

FIG. 4 is a Venn diagram that shows logical groupings of questions for several conditions.

FIG. 5 is an illustration of question ranking and condition ranking for some exemplary questions and conditions.

FIG. 6 is a flowchart of a method that is performed by the program module of FIG. 2 (or its subordinate modules).

A component or a feature that is common to more than one drawing is indicated with the same reference number in each of the drawings.

### DESCRIPTION OF THE INVENTION

The present invention provides for a system that assists a medical professional, e.g., a doctor, in diagnosing symptoms of a patient to diagnose a medical condition. The system provides a personalized, accurate diagnosis, and treatment support, for both the medical professional and the patient. The system includes a web-based application that provides portals for each of the patient and the doctor, a knowledge registry that is populated with information about various conditions, and a diagnostic engine. The patient provides some initial information that includes answers to some initial questions, and the doctor provides additional information while interviewing or observing the patient. Additionally, the system accesses a medical history about the patient. The diagnostic engine evaluates the information from the patient, the doctor and the medical history, and matches the information to one or more conditions in the knowledge registry. Based on the matches to the one or more conditions, the diagnostic engine then suggests follow-up questions, and a possible diagnosis.

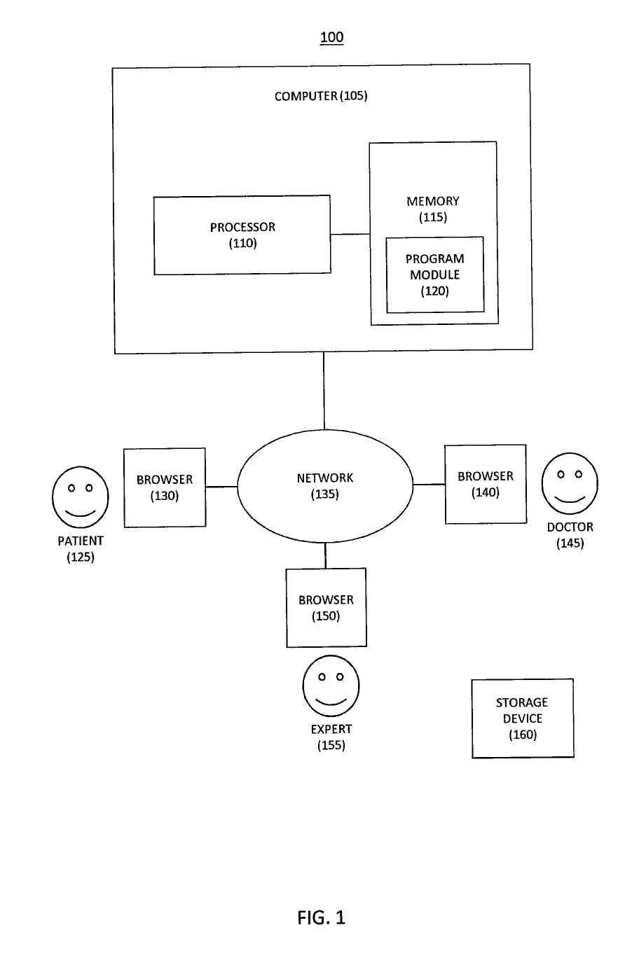

FIG. 1 is a block diagram of a system 100, for employment of the present invention. System 100 includes a computer 105 coupled to a network 135, e.g., the Internet.

Computer 105 includes a processor 110, and a memory 115. Although computer 105 is represented herein as a standalone device, it is not limited to such, but instead can be coupled to other devices (not shown) in a distributed processing system.

Processor 110 is an electronic device configured of logic circuitry that responds to and executes instructions.

Memory 115 is a computer-readable storage medium encoded with a computer program. In this regard, memory 115 stores data and instructions that are readable and executable by processor 110 for controlling the operation of processor 110. Memory 115 may be implemented in a random access memory (RAM), a hard drive, a read only memory (ROM), or a combination thereof. One of the components of memory 115 is a program module 120.

Program module 120 contains instructions for controlling processor 110 to execute methods described herein. The term “module” is used herein to denote a functional operation that may be embodied either as a stand-alone component or as an integrated configuration of a plurality of sub-ordinate components. Thus, program module 120 may be implemented as a single module or as a plurality of modules that operate in cooperation with one another. In the present document, although we describe operations being performed by program module 120, or methods or modules therein, the operations are actually being performed by processor 110.

Program module 120 is described herein as being installed in memory 115, and therefore being implemented in software. However, program module 120 could be implemented in any of hardware (e.g., electronic circuitry), firmware, software, or a combination thereof.

Also, while program module 120 is indicated as being already loaded into memory 115, it may be configured on a storage device 160 for subsequent loading into memory 115. Storage device 160 is a computer-readable storage medium and can be any conventional storage medium that stores program module 120 thereon in tangible form. Examples of storage device 160 include a compact disk, a magnetic tape, a read only memory, an optical storage media, a hard drive or a memory unit consisting of multiple parallel hard drives, and a universal serial bus (USB) flash drive. Alternatively, storage device 160 can be a random access memory, or other type of electronic storage, located on a remote storage system and coupled to computer 105 via network 135.

Computer 105 is communicatively coupled, via network 135, to a browser 130, a browser 140, and a browser 150. Browser 130 is operated by a patient 125 who is seeking medical treatment. Browser 140 is operated by a medical professional such as a nurse or a doctor, and in the present case a doctor 145, who is presently, or who expects to be, treating patient 125. Browser 150 is operated by a medical expert, e.g., a doctor or a researcher, designated herein as an expert 155, who provides expert knowledge to program module 120 for utilization by program module 120 in the diagnosis of a medical condition. For example, expert 155 may be an expert in the diagnosis of gout. Ordinarily, expert 155 will not have a personal relationship with either of patient 125 or doctor 145. Each of browsers 130, 140 and 150 is a device, such as a desk-top computer, through which its respective user (e.g., patient 125, doctor 145 and expert 155) communicates with computer 105.

In a practical application, system 100 will be utilized by a plurality of patients such as patient 125, a plurality of doctors such as doctor 145, and a plurality of experts such as expert 155.

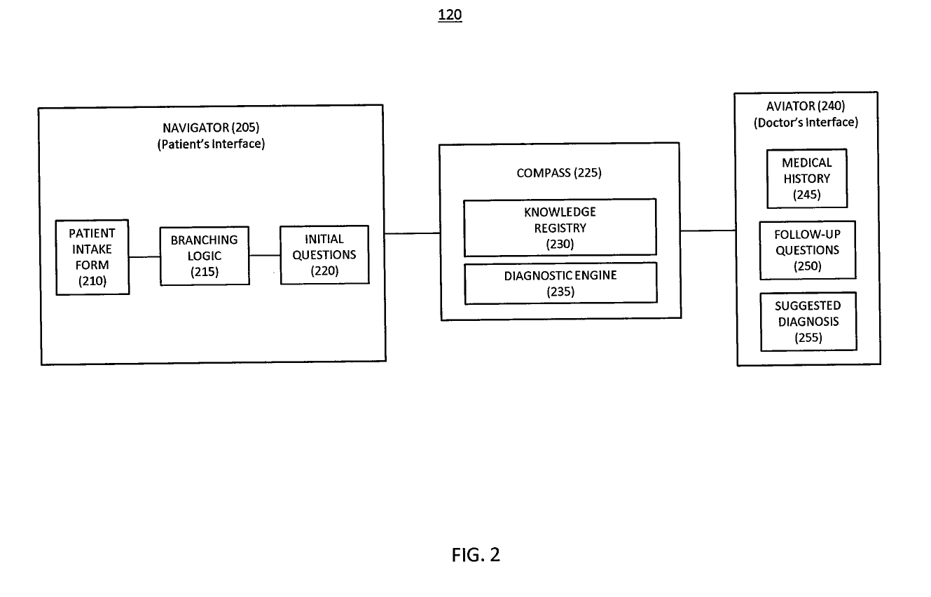

FIG. 2 is a functional block diagram of program module 120. Program module 120 is a web-based application that communicates with patient 125, doctor 145 and expert 155 via their respective browsers 130, 140 and 150.

An embodiment of the present invention is being contemplated for use in a product that includes components referred to as a Navigator, a Compass and an Aviator. Accordingly, the major components of program module 120 are a Navigator 205, a Compass 225 and an Aviator 240.

Navigator 205 is a portal through which patient 125 communicates with program module 120. Navigator 205 includes a patient intake form 210, branching logic 215, and initial questions 220.

Ordinarily, patient 125 will utilize Navigator 205 in advance of patient 125 visiting doctor 145. Navigator 205 collects from patient 125, information concerning a proposed visit by patient 125 to the office of doctor 145. For example, Navigator 205 will ask patient 125 to provide information about an ailment or symptom. In this regard, Navigator 205 presents patient 125 with a set of one or more questions from initial questions 220. Patient 125 responds to the set of one or more questions by providing information on patient intake form 210. Based on those responses, branching logic 215 selects and presents to patient 125, additional questions from initial questions 220. Accordingly, patient 125 responds to the additional questions by providing more information on patient intake form 210, and based on that information, branching logic 215 may present additional questions. This presentation of questions and the selection of additional questions by branching logic 215 may continue for several rounds. Initial questions 220 contains many questions, e.g., 15,000 questions, but due to the efforts of branching logic 215, only a relatively small number of questions, e.g., 20 questions, will actually be presented to patient 125. In the end, patient intake form 210 is a collection of basic information about patient 125, provided by patient 125.

Aviator 240 is a portal through which doctor 145 communicates with program module 120. Aviator 240 includes a medical history 245 of patient 125, which may be stored in Aviator 240, or be obtained by Aviator 240 from an external storage device (not shown). Through Aviator 240, doctor 145 enters information about patient 125 based on answers to questions presented to patient 125, or other observations being made by doctor 145. Aviator 240 may also obtain information about patient 125 from sources such as monitoring equipment (not shown), e.g., a blood pressure monitor or a heart rate monitor.

Compass 225 is a portal through which expert 155 communicates with program module 120. As mentioned above, expert 155 is a doctor or a researcher who provides expert knowledge to program module 120 for utilization by program module 120 in the diagnosis of a medical condition.

Compass 225 includes a knowledge registry 230 and a diagnostic engine 235. Diagnostic engine 235 evaluates patient intake form 210, medical history 245, information provided by doctor 145, and information from other sources such as monitoring equipment, in view of information in knowledge registry 230. Based on the evaluation, diagnostic engine 235 suggests a possible diagnosis and one or more follow-up questions, which it sends to Aviator 240 in the form of suggested diagnosis 255 and follow-up questions 250. Aviator 240 presents suggested diagnosis 255 and follow-up questions 250 to doctor 145 via browser 140.

Knowledge registry 230 is a database having data that identifies conditions, and questions pertaining to the conditions, where a given question may pertain to more than one condition. For example, the question “Does the patient have a fever?” may pertain to many conditions. For each condition, the questions are weighted and ranked with regard to their relevance to the condition. Thereafter, for each condition, relevant questions are grouped into a set.

The conditions, questions, weights and rankings are among the data in knowledge registry 230, and are designated by expert 155. As such, the data in knowledge registry 230 is regarded as validated evidence.

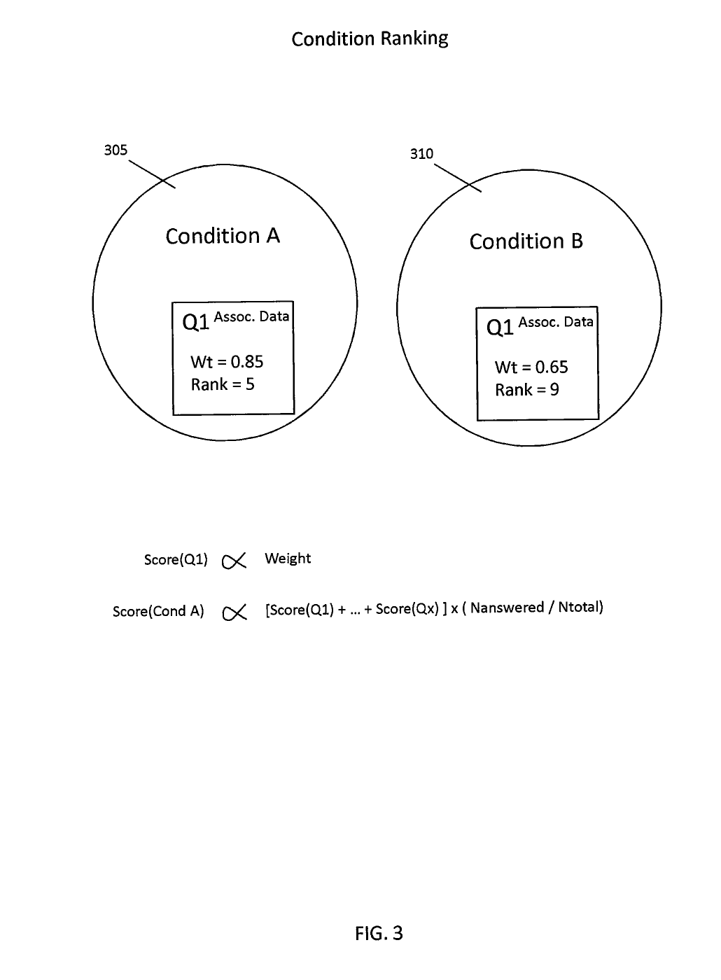

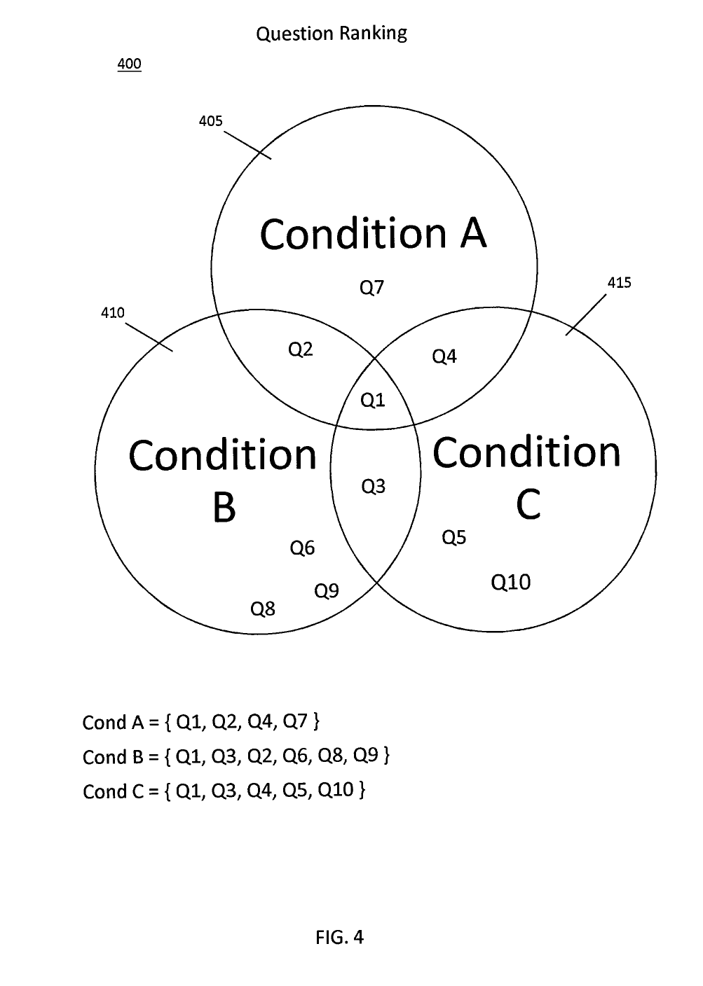

Concepts of the weighting and grouping are discussed with reference to FIGS. 3 and 4.

FIG. 3 is diagram 300 that shows condition ranking for a question Q1 and two conditions A 305 and B 310.

For condition A 305, question Q1 is regarded as having a weight of 0.85 and a rank of 5. For condition B 310, question Q1 is regarded as having a weight of 0.65 and a rank of 9.

Diagram 300 also shows that the weight of question Q1 is used to produce a score for condition A 305. Although not shown in diagram 300, the weight of question Q1 would also be used to produce a score for condition B 310. The significance of the score is described below in greater detail.

FIG. 4 is a Venn diagram, i.e., diagram 400, that shows logical groupings of questions for several conditions. Diagram 400 includes conditions A 405, B 410 and C 415, each of which is represented by a circle, and questions designated as Q1-Q10.

Assume that questions Q1-Q10 have not yet been answered. The unanswered questions are ranked in terms of their commonality to condition sets. This process is referred to herein as question ranking.

Condition A 405 encompasses questions Q1, Q2, Q4 and Q7. That is, questions Q1, Q2, Q4 and Q7 pertain to condition A 405.

Condition B 410 encompasses questions Q1, Q2, Q3, Q6, Q8 and Q9. That is, questions Q1, Q2, Q3, Q6, Q8 and Q9 pertain to condition B 410.

Condition C 415 encompasses questions Q1, Q3, Q4, Q5 and Q10. That is, questions Q1, Q3, Q4, Q5 and Q10 pertain to condition C 415.

In diagram 400, Q1 carries the least information as it provides no discriminatory information between conditions A 405, B 410 and C 415. That is, since Q1 is common to each of conditions A 405, B 410 and C 415, its answer does not lead to a conclusion that any one of conditions A 405, B 410 and C 415 is more likely than the other two. However, Q10 is unique to condition C 415. As such, an affirmative answer to Q10 suggests that condition C 415 is more likely than the other conditions.

### Exemplary Questions and Conditions

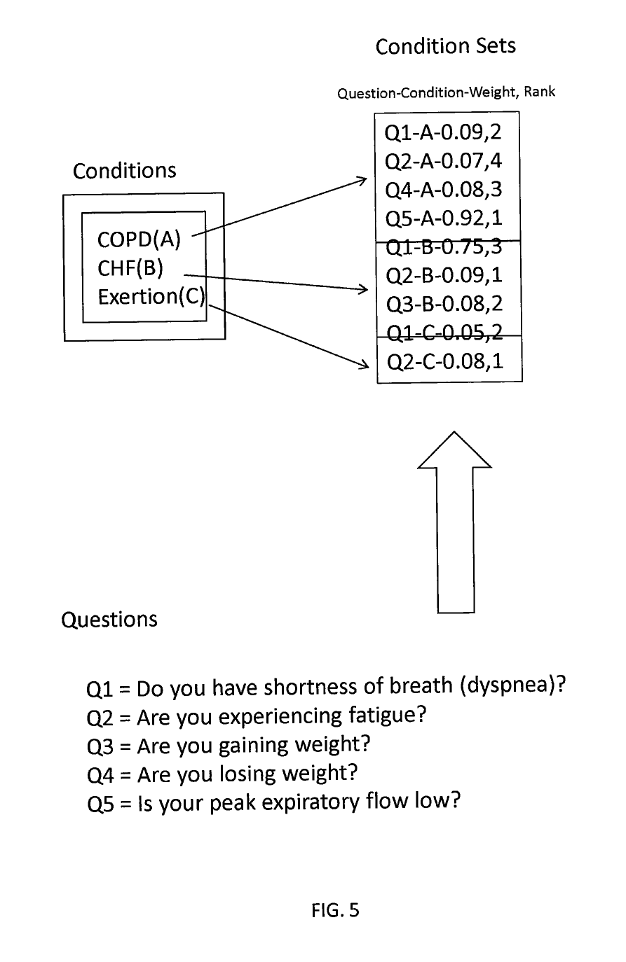

FIG. 5 is an illustration of question ranking and condition ranking for some exemplary questions and conditions. Conditions and questions are linked via the condition sets holding measures that define a degree of linkage of a question to a condition via weight and a rank.

The questions are:
Q1: Do you have shortness of breath (dyspnea)?
Q2: Are you experiencing fatigue?
Q3: Are you gaining weight?
Q4: Are you losing weight?
Q5: Is your peak expiratory flow low?

The conditions are:
Condition A: Chronic Obstructive Pulmonary Disease (COPD)
Condition B: Congestive Heart Failure (CHF)
Condition C: Over Exertion.

Tables 1-3, below, show conditions sets, i.e., relevant questions, and weighting and ranking of the questions, for each of the three conditions.

TABLE 1
Condition A: Chronic Obstructive Pulmonary Disease (COPD)

| Question/Answer | Weight | Rank |
|---|---|---|
| Q5: Is your peak expiratory flow low?/Yes | 0.92 | 1 |
| Q1: Do you have shortness of breath (dyspnea)?/Yes | 0.90 | 2 |
| Q4: Are you losing weight?/Yes | 0.80 | 3 |
| Q2: Are you experiencing fatigue?/Yes | 0.70 | 4 |

TABLE 2
Condition B: Congestive Heart Failure (CHF)

| Question/Answer | Weight | Rank |
|---|---|---|
| Q2: Are you experiencing fatigue?/Yes | 0.90 | 1 |
| Q3: Are you gaining weight?/Yes | 0.80 | 2 |
| Q1: Do you have shortness of breath (dyspnea)?/Yes | 0.75 | 3 |

TABLE 3
Condition C: Over Exertion

| Question/Answer | Weight | Rank |
|---|---|---|
| Q2: Are you experiencing fatigue?/Yes | 0.80 | 1 |
| Q1: Do you have shortness of breath (dyspnea)?/Yes | 0.50 | 2 |

For example, as indicated by Table 1, condition A (COPD) has a condition set of four questions (i.e., Q1, Q2, Q4 and Q5). Question Q5 has the greatest weight, i.e., 0.92, and is has the highest ranking, i.e., 1. This means that of the four questions, Q5, Q1, Q4 and Q2, Q5 would provide the most insight as to whether a patient has COPD.

Note, with reference to all of Tables 1-3, that question Q1, “Do you have shortness of breath (dyspnea)?”, is common to all of conditions A, B and C. Thus, shortness of breath is considered to be a symptom of each of conditions A, B and C. However, question Q1 is weighted and ranked differently for each of the three conditions. For example, in Table 1, for condition A, question Q1 has a weight of 0.90 and a rank of 2, while in Table 3, for condition C, question Q1 has a weight of 0.50 and a rank of 2. This means that with regard to condition A, question Q1 is a relatively important indicator as compared to questions Q4 and Q2, and with regard to condition C, question Q1 is a less important indicator than question Q2.

Note also, with reference to all of Tables 1-3, that question Q5 is unique to condition A (COPD). That is, the answer to question Q5 has no relevance to a determination of whether a patient has either of conditions B or C.

In operation, diagnostic engine 235 evaluates answers to questions, ranks conditions (based on weights of the answered questions), ranks unanswered questions. The ranking of the conditions includes determining scores for the conditions, where the scores are used to identify likely conditions, which are presented as suggested diagnosis 255. The ranking of the unanswered questions yields one or more follow-up questions 250.

Conditions are ranked according to Equation 1:

Score (Condition)=(Σweights)×(N_{answered}/Nₜₒₜₐₗ) (Equation 1)

where, for a particular condition, Nₜₒₜₐₗ is the total number of questions in the condition set, and N_{answered} is the number of questions in condition set that have been answered in the affirmative. Thus, the ratio N_{answered}/Nₜₒₜₐₗ indicates the proportion of questions in the condition set that have been answered in the affirmative.

For condition A, there are four questions in the condition set, and therefore, Nₜₒₜₐₗ=4.

For condition B, there are three questions in the condition set, and therefore, Nₜₒₜₐₗ=3.

For condition C, there are two questions in the condition set, and therefore, Nₜₒₜₐₗ=2.

### Initial Entry

As mentioned above, Navigator 205 presents patient 125 with a set of one or more questions from initial questions 220, and patient 125 provides answers on patient intake form 210. Initial questions 220 are a subset of a larger number questions that are available in knowledge registry 230. Assume that while patient 125 was filling out patient intake form 210, Navigator 205 asked only one the questions Q1-Q5, namely, question Q1, and patient 125 answered question Q1 in the affirmative, i.e., indicating that patient 125 suffers shortness of breath.

### Initial Condition Ranking

For condition A, Q1 has a weight of 0.90, and the proportion of questions answered is 1/4. According to Equation 1:

Score (Condition A)=(0.90)×(1/4)=0.225

For condition B, Q1 has a weight of 0.75, and the proportion of questions answered is 1/4. According to Equation 1:

Score (Condition B)=(0.75)×(1/3)=0.25

For condition C, Q1 has a weight of 0.50, and the proportion of questions answered is 1/4. According to Equation 1:

Score (Condition C)=(0.50)×(1/2)=0.25

Thus, conditions B and C are tied for a highest score, i.e., 0.25, while condition A has the lowest score, i.e., 0.225. As a tie-breaker, one of conditions B and C is arbitrarily selected, and the condition ranking is designated as C, B, A. However, relatively speaking, they are all very close in score and no clear candidate has emerged.

Diagnostic engine 235 sends these three conditions and their scores to Aviator 240 as suggested diagnosis 255, and Aviator 240 presents them to doctor 145 on browser 140.

### Initial Question Ranking

Recall that so far, only question Q1 has been answered, and as such, questions Q2-Q5 are unanswered. For all conditions with at least one answered question, all unanswered questions will be partitioned into groups with lessening degrees of uniqueness, starting with questions unique to that condition, to questions shared with one other condition and so on. These will be denoted as group sets, GSn, with n denoting the degree of uniqueness, where n=1 is unique questions, n=2 represents questions shared with one other condition, n=3 represents questions shared with two other conditions, etc. Additionally within these group sets, the highest weighted questions appear before the lesser weighted questions. Apply this to the unanswered questions yields:
GS1=Condition A {Q5, Q4}, Condition B {Q3}
GS3=Conditions A, B, C {Q2}

GS1 designates questions that are unique to one condition. There are three unanswered questions, i.e., questions Q3, Q4 and Q5, that are unique to one condition. More specifically, questions Q4 and Q5 are unique to condition A, and question Q3 is unique to condition B. Within the group for condition A, question Q5 appears before question Q4 because, for condition A, the weight of question Q5, i.e., 0.92, is greater than the weight of question Q4, i.e., 0.80.

GS2 designates questions that are shared by two conditions. There are no questions that are shared by two conditions. As such, there is no GS2.

GS3 designates questions that are shared by three conditions. Question Q2 is shared by conditions A, B and C.

Next, considering from the highest Ranked condition to lowest ranked condition, a question is selected from the GS1 groups of each. If none is available from a particular GSn tier, a question is selected from the next most unique GSn group (i.e., lowest n). However, this lowers the question's order behind the questions that came from the current lower GSn group.

In this case, since question Q2 belongs to the highest ranked group, it is placed after questions Q3 and Q5 as they are from a lower GSn group.

This grouping of questions is redone until all questions have been used. This results in a new order of questions for presenting to patient 125.

In the present example, the resultant question order is Q3, Q5, Q2, Q4. That is:
Q3: Are you gaining weight?
Q5: Is your peak expiratory flow low?
Q2: Are you experiencing fatigue?
Q4: Are you losing weight?

Accordingly, diagnostic engine 235 sends questions Q3, Q5, Q2 and Q4 to Aviator 240 in the form of follow-up questions 250, and Aviator 240 presents these questions to doctor 145 on browser 140.

Below, we are presenting three examples of operations by program module 120 based on answers to questions Q3, Q5, Q2 and Q4. Each of the three examples will illustrate a diagnosis of one of condition A, condition B or condition C.

### Example 1

### Diagnosis of Condition A (COPD)

### Example 1

### Iteration 1

Assume that when presented with questions Q3, Q5, Q2 and Q4, patient 125 does not answer question Q3. That is, patient 125 is not gaining weight. However, patient 125 (or doctor 145) answers question Q5 in the affirmative, thus indicating that patient 125 has a low peak expiratory flow.

For condition ranking:

Score (Condition A)=(0.90+0.92)×(2/4)=0.91

Score (Condition B)=(0.75)×(1/3)=0.25

Score (Condition C)=(0.50)×(1/2)=0.25

Accordingly, the conditions are ranked in order A, C, B, and relatively speaking, condition A is emerging as a clear candidate having a score 3.64 times its next nearest rival. Diagnostic engine 235 sends this condition ranking to Aviator 240 as suggested diagnosis 255, and Aviator 240 presents it to doctor 145 on browser 140.

For question ranking:
GS1=Condition A {Q4}, Condition B {Q3}
GS3=Conditions A, B, C {Q2}

The resultant question order is Q4, Q3, Q2. That is:
Q4: Are you losing weight?
Q3: Are you gaining weight?
Q2: Are you experiencing fatigue?

Diagnostic engine 235 sends questions Q4, Q3 and Q2 to Aviator 240 in the form of follow-up questions 250, and Aviator 240 presents these questions to doctor 145 on browser 140.

### Example 1

### Iteration 2

Assume that when presented with questions Q4, Q3 and Q2, patient 125 (or doctor 145) answers question Q4 in the affirmative, thus indicating that patient 125 is losing weight.

For condition ranking:

Score (Condition A)=(0.90+0.92+0.80)×(3/4)=1.965

Score (Condition B)=(0.75)×(1/3)=0.25

Score (Condition C)=(0.50)×(1/2)=0.25 (Threshold event)

Note that condition A has a score that is now substantially greater than that of its nearest rival and is the clear dominant candidate in the diagnosis. Additionally, condition A has passed a threshold event in that all its unique questions are answered. Diagnostic engine 235 sends this condition ranking and notice of the threshold event to Aviator 240 as suggested diagnosis 255, and Aviator 240 presents it to doctor 145 on browser 140.

For question ranking:
GS1=Condition B {Q3}
GS3=Conditions A, B, C {Q2}

The resultant question order is Q3, Q2. That is:
Q3: Are you gaining weight?
Q2: Are you experiencing fatigue?

These questions are communicated to doctor 145 via browser 140.

### Example 1

### Iteration 3

Assume that when presented with questions Q3 and Q2, patient 125 does not answer Q3. That is, patient 125 is not gaining weight. However, patient 125 (or doctor 145) answers question Q2 in the affirmative, thus indicating that patient 125 is experiencing fatigue.

For condition ranking:

Score (Condition A)=(0.90+0.92+0.80+0.70)×(4/4)=3.32

Score (Condition B)=(0.75+0.90)×(2/3)=1.1 (Threshold event)

Score (Condition C)=(0.50+0.80×(2/2)=1.3 (Threshold event)

Condition A has a score that is still substantially greater than that of its nearest rival, although it has dropped from the score in the previous iteration. Each of conditions A and C have passed a threshold event in that all their questions are answered. Diagnostic engine 235 sends this condition ranking and notice of the threshold event to Aviator 240 as suggested diagnosis 255, and Aviator 240 presents it to doctor 145 on browser 140.

For question ranking:
GS1=Condition B {Q3}

Thus, the remaining question is:
Q3: Are you gaining weight?

As in prior iterations, patient 125 does not answer question Q3, but for the present example, there are no further questions.

At this point, suggested diagnosis 255 is indicating that condition A, i.e., COPD, is a most likely condition.

### Example 2

### Diagnosis of Condition B (CHF)

### Example 2

### Iteration 1

Assume that when presented with questions Q3, Q5, Q2 and Q4, patient 125 (or doctor 145) answers question Q3 in the affirmative, thus indicating that patient 125 is gaining weight.

For condition ranking:

Score (Condition A)=(0.90)×(1/4)=0.225

Score (Condition B)=(0.75+0.80)×(2/3)=1.033

Score (Condition C)=(0.50)×(1/2)=0.25 (Threshold event)

Accordingly, the conditions are ranked in order B, C, A, and relatively speaking, condition B is emerging as a candidate having a score that is more than 4 times its next nearest rival. Additionally, condition B has passed a threshold event in that all of its unique questions have been answered. Diagnostic engine 235 sends this condition ranking and notice of the threshold event to Aviator 240 as suggested diagnosis 255, and Aviator 240 presents it to doctor 145 on browser 140.

For question ranking:
GS1=Condition A {Q5, Q4}
GS3=Conditions A, B, C {Q2}

The resultant question order is Q5, Q2, Q4. That is:
Q5: Is your peak expiratory flow low?
Q2: Are you experiencing fatigue?
Q4: Are you losing weight?

Accordingly, diagnostic engine 235 sends questions Q5, Q2 and Q4 to Aviator 240 in the form of follow-up questions 250, and Aviator 240 presents these questions to doctor 145 on browser 140.

### Example 2

### Iteration 2

Assume that when presented with questions Q5, Q2 and Q4, patient 125 does not answer question Q5. That is, patient 125 does not have a low peak expiratory flow. However, patient 125 (or doctor 145) answers question Q2 in the affirmative, thus indicating that patient 125 is experiencing fatigue.

For condition ranking:

Score (Condition A)=(0.90+0.70)×(2/4)=0.80

Score (Condition B)=(0.75+0.80+0.90)×(3/3)=2.45 (Threshold event)

Score (Condition C)=(0.50+0.80)×(2/2)=1.3 (Threshold event)

Accordingly, the conditions are ranked in order B, C, A, and condition B is emerging as a dominant candidate. Additionally, each of conditions B and C has passed a threshold event in that all its questions have been answered. Diagnostic engine 235 sends this condition ranking and notice of the threshold events to Aviator 240 as suggested diagnosis 255, and Aviator 240 presents it to doctor 145 on browser 140.

For question ranking:
GS1=Condition A {Q5, Q4}

The resultant question order is Q5, Q4. That is:
Q5: Is your peak expiratory flow low?
Q4: Are you losing weight?

Accordingly, diagnostic engine 235 sends questions Q5 and Q4 to Aviator 240 in the form of follow-up questions 250, and Aviator 240 presents these questions to doctor 145 on browser 140.

However, as in iteration 2, patient 125 does not answer question Q5, and in iteration 1, patient 125 answered question Q3, thus indicating that patient 125 is gaining weight. Since patient 125 has already indicated that patient 125 is gaining weight, patient 125 cannot answer question Q4 in the affirmative.

At this point, suggested diagnosis 255 is indicating that condition B, i.e., CHF, is a most likely condition.

### Example 3

### Diagnosis of Condition C (Over Exertion)

### Example 3

### Iteration 1

Assume that when presented with questions Q3, Q5, Q2 and Q4, patient 125 does not answer either of questions Q3 or Q5. That is, patient 125 is not gaining weight and does not have a low peak expiratory flow. However, patient 125 (or doctor 145) answers question Q2 in the affirmative, thus indicating that patient 125 is experiencing fatigue.

For condition ranking:

Score (Condition A)=(0.90+0.70)×(2/4)=0.80

Score (Condition B)=(0.75+0.90)×(2/3)=1.1

Score (Condition C)=(0.50+0.80)×(2/2)=1.3 (Threshold event)

Accordingly, the conditions are ranked in order C, B, A, and condition C is emerging as a leading candidate. The scores for conditions B and C are relatively close to one another, but this represents a lack of discriminatory data as all of the questions for condition C are a subset of both conditions A and B. However, condition C has passed a threshold event as all its questions are answered. Diagnostic engine 235 sends this condition ranking and notice of the threshold event to Aviator 240 as suggested diagnosis 255, and Aviator 240 presents it to doctor 145 on browser 140.

For question ranking:
GS1=Condition A {Q5, Q4}, Condition B {Q3}

The resultant question order is Q5, Q3, Q4. That is:
Q5: Is your peak expiratory flow low?
Q3: Are you gaining weight?
Q4: Are you losing weight?

Accordingly, diagnostic engine 235 sends questions Q5, Q3 and Q4 to Aviator 240 in the form of follow-up questions 250, and Aviator 240 presents these questions to doctor 145 on browser 140.

When presented with questions Q5, Q3 and Q4, patient 125 does not answer any questions. Thus, patient 125 does not have a low expiratory peak flow, is not gaining weight, and is not losing weight.

At this point, suggested diagnosis 255 is indicating that condition C, i.e., over exertion, is a most likely condition.

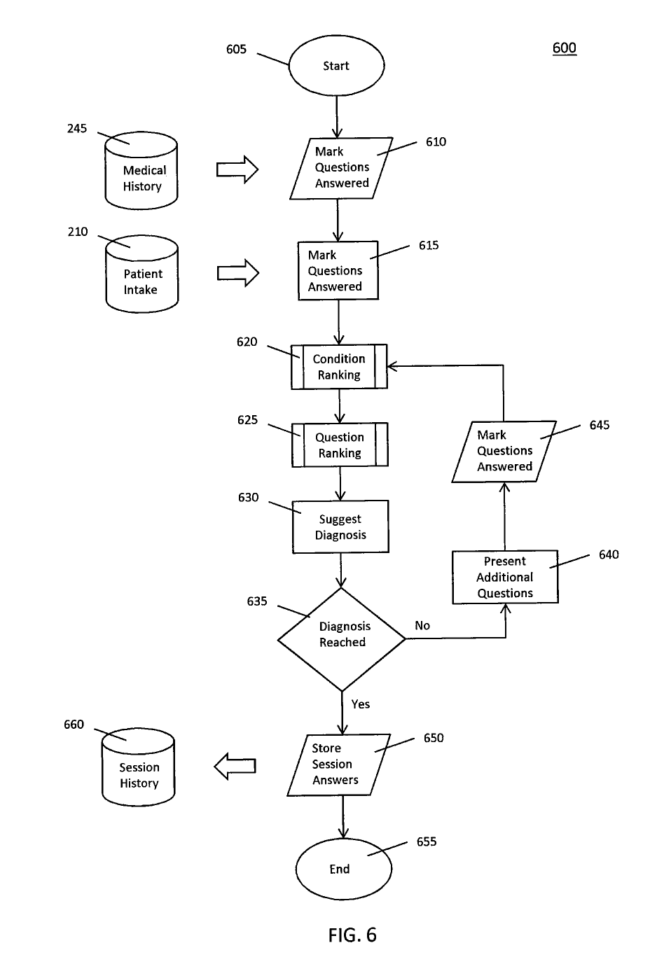

FIG. 6 is a flowchart of a method, designated herein as method 600, that is performed by program module 120 (or its subordinate modules). Method 600 starts at step 605 and progresses to step 610.

In step 610, diagnostic engine 235 reads patient 125′s medical history from medical history 245, and marks questions from knowledge registry 230 that have been answered in the affirmative. From step 610, method 600 progresses to step 615.

In step 615, diagnostic engine 235 reads patient intake form 210, and marks questions from knowledge registry 230 that have been answered in the affirmative. From step 615, method 600 progresses to step 620.

In step 620, diagnostic engine 235 matches the marked questions to conditions represented in knowledge registry 230, and performs a ranking of the conditions. From step 620, progresses to step 625.

In step 625, diagnostic engine 235 ranks unanswered questions. From step 625, method 600 progresses to step 630.

In step 630, diagnostic engine 235 sends a suggested diagnosis 255 to Aviator 240, which in turn, communicates suggested diagnosis 255 to doctor 145 via browser 140.

In step 635, Aviator 240 receives a communication from doctor 145 indicating whether doctor 145 has reached a diagnosis. If doctor 145 has not reached a diagnosis, method 600 progresses to step 640. If doctor 145 has reached a diagnosis, method 600 advances to step 650.

In step 640, diagnostic engine 235 sends follow-up questions 250 to Aviator 240, which in turn, presents the follow-up questions to doctor 145 via browser 140. From step 640, method 600 progresses to step 645.

In step 645, diagnostic engine 235 marks the follow-up questions that have been answered in the affirmative. From step 645, method 600 loops back to step 620.

In a case where method 600 loops back to step 620, diagnostic engine 235 will again perform operations of steps 620 and 625, thus yielding an updated suggested diagnosis and updated follow-up questions. Thereafter, in step 630, diagnostic engine 235 sends the updated suggested diagnosis to Aviator 240, which in turn, communicates the updated suggested diagnosis to doctor 145 via browser 140. In step 635, if doctor 145 indicates that a diagnosis has not yet been reached, then in step 640, diagnostic engine 235 sends the updated follow-up questions to Aviator 240, which in turn, communicates the updated follow-up questions to doctor 145 via browser 140.

In step 650 program module 120 stores the answers and in a session history database 660. From step 650, method 600 progresses to step 655.

In step 655, method 600 ends.

Although method 600 is shown as performing steps in a particular sequence, in practice, the steps may be performed in other sequences. For example, although step 640, i.e., the presentation of additional questions, is shown in FIG. 6 as being performed after step 635, i.e., the consideration of whether a diagnosis has been reached, the presentation of the additional questions can be performed before step 635, as part of step 630.

In summary, method 600 includes (a) receiving first information about a patient via a first user interface that is communicatively coupled to a communication network, (b) receiving second information about the patient via a second user interface that is communicatively coupled to the communication network, where the first information and the second information, together, comprise answered questions, (c) evaluating the answered questions, to yield a suggested diagnosis and a follow-up question, and (d) transmitting the suggested diagnosis and the follow-up question to the second user interface via the communication network.

Refer again to FIG. 2. Program module 120 matches personal data via Navigator 205 to a database of sets of evidence-based condition sets in Compass 225 with a moderating provider, i.e., Aviator 240. Aviator 240 visually displays the concepts mapped by Compass 225 for human exposure of information from the Navigator 205 to provide diagnostic likelihood and predictive intelligence. Asynchronously, Navigator 205 information is evaluated and verified, Compass 225 maps concepts with defined sets to display in Aviator 240 diagnostic likelihood and next question based on Shannon's information theory. Navigator 205, Aviator 240, and Compass 225 may be independent modules, or alternatively may be incorporated into one system as depicted in FIG. 1.

Navigator 205 is a client database and program that incorporates a pre-collection functionality with database storage. This pre-collection can be personally input by patients, parents or caregivers or derived via Natural Language Processing (NLP) and Name Entity Recognition (NER) Navigator 205 can allow a client to enter their chief complaint (CC), history of present illness (HPI), personal, family and social history (PFSH) on a HIPAA-secure portal, prior to an office, phone or e-visit or the data can be imported using a specialized natural language processing (NLP) platform with a vast conceptual terminology database plus syntax and context analytics that can mine moderators of concepts buried in free text and narrative notes in a hospital record or electronic medical record and pre-populate or transfer to Navigator 205 and/or Aviator 240.

Compass 225 may be another database that can be derived from invited physicians contributing evidence-based medicine condition sets of concept questions. Compass 225 may allow invited physicians to contribute and store current evidence, personal expertise and experience thereby creating evidence-based standardized condition sets (discussed further below). Compass 225 is open and transparent. Compass 225 may further incorporate an oversight Medical Advisory Board to facilitate and monitor information stored in Compass 225 for critique, queries and discussion. Aviator 240 may be in communication with Compass 225 and access stored information to visually display personalized cognitive support and next question. Additionally, Aviator 240 may be in communication with Navigator 205 to access pertinent patient information. Information provided by Navigator 205 and Compass 225 may be processed and displayed by Aviator 240 resulting in a diagnostic and treatment predictive solution. Such processing may also be provided by Navigator 205 or Compass 225, or a combination thereof. Such information may include but is not limited to personalized patient information, qualitative results, evidence-based tests, check lists, red flags, differential diagnostic suggestions, management/treatment validation, next question and cognitive support at the point of care and visualized in Navigator 205 or Aviator 240.

The present disclosure also provides for a continuous feedback loop of decision making by doctor 145. The diagnosis made by doctor 145 is entered into knowledge registry 230, thus providing collective intelligence. Continuous processing analyzes user-generated evidence and resulting successful diagnosis and management to create smarter recommendations based on real-world use. The future recommendations are based on the quantity of similar successful evidence-based diagnosis recognized as part of the artificial intelligence (AI).

Compass 225 is a content management system (CMS) that may acquire, organize, structure, parse, index and vet evidence-based medical information, physician expertise, physician experience, or combinations thereof, to create an actionable database by methods of a collaborative, crowd-sourced manner. Compass 225 may store a compilation of pre-existing material, facts, and data by a collaborative group of physicians from around the world. Compass 225 can be open, transparent and visible for all approved collaborators to: use, challenge, critique, and refine. Access to Compass 225 can be provided all the time. Access may require user authentication and an additional user account with associated user name(s) and password(s) to ensure security and integrity of Compass 225. As such, data stored in Compass 225 may be restricted for third party use and/or restricted from transposing into another database. It should be noted that such methods of access—via an account with associated user name(s) and user password(s)—may be incorporated in Navigator 205 and Aviator 240.

Compass 225 is a searchable, structured information repository, designed to support evidence-based (herein after “EB”) medical diagnosis and management including expert/physician-specific experience and expertise. Compass 225 may include information gathered from a drag and drop menu to select EB concepts and assemble specific patient-case condition sets. The sub-level concepts selected for each condition may include, but is not limited to basic, chief complaint, risk factors, history of present illness, review of systems, vital signs, social history, family history, clinical manifestations, physical exam, allergies, immunizations, surgeries, hospitalizations, labs, imaging, procedures/test, differentials, co-morbidities, diagnostic definitive's, the art of medicine, treatment plan, education, prevention, non-pharmaceutical treatment, procedures, experimental treatment, referral, prognosis, and pharmaceutical treatment. Compass 225 is where each of the EB concepts and values (Definitive Eliminators, Weights and Ranking Occurrence and Noise) are entered for each related data element or atomic concept into each condition set. Data may be input as concepts to auto-populate the condition sets and new concepts can be added at anytime. Free text is entered for overview, epidemiology, pathophysiology, etiology, information, warnings, and checklists with accompanying references to support each concept. This free text can also be incorporated via the NLP system used for structuring unstructured data. Supplemental information including references, images, videos, are input and can be tagged for the appropriate library.

Compass 225 allows for one primary author to initiate a condition with any number of patient condition sets including comorbidity sets. Any number of contributing authors can add to, edit or create a new set within that condition. When an edit, addition or deletion is made by a contributing author, an automatic email may be sent to the primary author regarding the change. The notified author may further respond to such changes. An internal medical expert can facilitate communication and fact check as a safeguard to insure correctness and safety. Additionally, any number of approved physicians can act as reviewers and can vet the condition sets and/or concepts. All authors and reviewers must be invited and approved before given access to the system. Physicians may refer and invite their peers. Any approved physician can begin or participate in discussion groups.

Compass 225 may also allow for medical lay people to edit, fact check, confirm and manage information in the compiled database. Compass 225 can be searched and referenced programmatically to enrich other applications. A group of Medical Advisors may act as an oversight committee to facilitate discussion and disputes.

Compass 225 may also incorporate a concepts field that can be filled using drag and drop techniques. This concepts field may include, but is not limited to: gender, age, chief complaint, what triggers chief complaint, what aggravates chief complaint, what improves chief complaint, what accompanies chief complaint, review of systems, location, risk factors, wherein risk factors include but are not limited to: personal history, family history, and social history, immunizations, allergies, hospitalizations, surgeries; clinical manifestations, wherein clinical manifestations may include, but are not limited to duration, onset, severity, comorbidities, vital signs, physical exam, labs, imaging, education, prevention, non-pharmacologic management, pharmacologic management, procedures, referral, prognosis.

Thus, computer 105 is a system for matching and mapping person-specific data with evidence. In this regard, computer 105 includes (a) a collaborative knowledge registry operable and accessible by a processor, the collaborative knowledge registry adapted for storing a registry condition and a registry diagnosis, where the registry condition is associated with the registry diagnosis, (b) a client profile in communication with the processor, where the client profile is adapted to store a client condition, (c) a provider portal adapted to access the client profile and validate the client condition resulting in a validated client condition, where the provider portal is in communication with the processor, the processor being adapted to correlate the validated client condition with the registry condition resulting in a match, and (d) an access device in communication with the processor, where the access device is adapted to display and store the registry diagnosis associated with the registry condition identified in the match.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method comprising:
receiving first information about a patient via a first user interface that is communicatively coupled to a communication network;
receiving second information about said patient via a second user interface that is communicatively coupled to said communication network, wherein said first information and said second information, together, comprise answered questions;
evaluating said answered questions, to yield a suggested diagnosis and a follow-up question; and
transmitting said suggested diagnosis and said follow-up question to said second user interface via said communication network.

2. The method of claim 1, further comprising:
receiving an answer to said follow-up question via said second user interface;
evaluating said answer to said follow-up question, to yield an updated suggested diagnosis and an updated follow-up question; and
transmitting said updated suggested diagnosis and said updated follow-up question to said second user interface.

3. The method of claim 1,
wherein said first information is provided by said patient via said first user interface in advance an examination of said patient by a medical professional; and
wherein said second information is provided by said medical professional via said second user interface during said examination.

4. The method of claim 1, wherein said evaluating comprises:
matching said answered questions to conditions in a database;
ranking said conditions based on a relevance of said answered questions to said conditions, to yield said suggested diagnosis;
accessing, from said database, unanswered questions concerning said conditions; and
ranking said unanswered questions based on a relevance of said unanswered questions to said conditions to yield said follow-up question.

5. The method of claim 4, further comprising:
receiving, via a third user interface that is communicatively coupled to said communication network, a new question pertaining to a condition, and a relevance of an answer to said new question to said condition; and
updating said database to include said new question and said relevance of said answer to said new question to said condition.

6. A system comprising:
a processor; and
a memory that contains instructions that when read by said processor cause said processor to:
receive first information about a patient via a first user interface that is communicatively coupled to a communication network;
receive second information about said patient via a second user interface that is communicatively coupled to said communication network, wherein said first information and said second information, together, comprise answered questions;
evaluate said answered questions, to yield a suggested diagnosis and a follow-up question; and
transmit said suggested diagnosis and said follow-up question to said second user interface via said communication network.

7. The system of claim 6, wherein said instructions also cause said processor to:
receive an answer to said follow-up question via said second user interface;
evaluate said answer to said follow-up question, to yield an updated suggested diagnosis and an updated follow-up question; and
transmit said updated suggested diagnosis and said updated follow-up question to said second user interface.

8. The system of claim 6,
wherein said first information is provided by said patient via said first user interface in advance an examination of said patient by a medical professional; and
wherein said second information is provided by said medical professional via said second user interface during said examination.

9. The system of claim 6, wherein to evaluate said answer, said instructions cause said processor to:
match said answered questions to conditions in a database;
rank said conditions based on a relevance of said answered questions to said conditions, to yield said suggested diagnosis;
access, from said database, unanswered questions concerning said conditions; and
rank said unanswered questions based on a relevance of said unanswered questions to said conditions to yield said follow-up question.

10. The system of claim 9, wherein said instructions also cause said processor to:
receive, via a third user interface that is communicatively coupled to said communication network, a new question pertaining to a condition, and a relevance of an answer to said new question to said condition; and
updating said database to include said new question and said relevance of said answer to said new question to said condition.

11. A storage device comprising instructions that, when read by a processor, cause said processor to:
receive first information about a patient via a first user interface that is communicatively coupled to a communication network;
receive second information about said patient via a second user interface that is communicatively coupled to said communication network, wherein said first information and said second information, together, comprise answered questions;
evaluate said answered questions, to yield a suggested diagnosis and a follow-up question; and
transmit said suggested diagnosis and said follow-up question to said second user interface via said communication network.

12. The storage device of claim 11, wherein said instructions also cause said processor to:
receive an answer to said follow-up question via said second user interface;
evaluate said answer to said follow-up question, to yield an updated suggested diagnosis and an updated follow-up question; and
transmit said updated suggested diagnosis and said updated follow-up question to said second user interface.

13. The storage device of claim 11,
wherein said first information is provided by said patient via said first user interface in advance an examination of said patient by a medical professional; and
wherein said second information is provided by said medical professional via said second user interface during said examination.

14. The storage device of claim 11, wherein to evaluate said answer, said instructions cause said processor to:
match said answered questions to conditions in a database;
rank said conditions based on a relevance of said answered questions to said conditions, to yield said suggested diagnosis;
access, from said database, unanswered questions concerning said conditions; and
rank said unanswered questions based on a relevance of said unanswered questions to said conditions to yield said follow-up question.

15. The storage device of claim 14, wherein said instructions also cause said processor to:
receive, via a third user interface that is communicatively coupled to said communication network, a new question pertaining to a condition, and a relevance of an answer to said new question to said condition; and
updating said database to include said new question and said relevance of said answer to said new question to said condition.
